(19) United States
(12) Patent Application Publication
(10) Pub. No.: US 2022/0151214 A1
(43) Pub. Date: May 19, 2022

(54) Lure Organizing Apparatus and Method

(71) Applicant: Rollie L. O'Dell, JR., Angleton, TX (US)

(72) Inventor: Rollie L. O'Dell, JR., Angleton, TX (US)

(21) Appl. No.: 16/952,522

(22) Filed: Nov. 19, 2020

(51) Int. Cl. A01K 97/06

(52) U.S. Cl. CPC A01K 97/06

(57) ABSTRACT

A securing apparatus for securing dangling hooks on a fishing lure having an elongated body. The elongated body has a first body end, and a second body end opposite the first body end. A first truncated body is integrally coupled to the first body end. The first truncated body has a first ridge. A second truncated body is integrally coupled to the second body end. The second truncated body has a second ridge.

### BACKGROUND

Recreational fishing, whether through competition or leisure, is enjoyed by many of those participating or spectating. The art of fishing may require aquatic vehicles that are as advanced as personal boats for deep sea fishing to simplistic tools such as coolers to store perishable items while fishing off a dock. Other tools may include fishing lures, fishing poles, nets, water-resistant shoes, etc. Managing this equipment can be cumbersome and overwhelming. In addition, handling some of the tools can pose a risk. For example, barb hooks coupled to fishing lures are hazardous when handled incorrectly or hastily. For example, a fisherman can be poked or stabbed when handling a fishing lure. The same issue occurs when the fisherman tries to decouple entangled fishing lures from one another when stored in a tacklebox. Safely managing and organizing fishing lures is a challenge.

### BRIEF DESCRIPTION OF THE DRAWINGS

FIG. 1 is perspective view of a securing apparatus.

FIG. 2 is an ariel view of a securing apparatus.

FIG. 3 is a profile view of a securing apparatus.

FIG. 4 is a profile view of a securing apparatus coupled to a fishing lure.

FIG. 5 is a profile view of two securing apparatus coupled to an array of fishing lures.

FIG. 6 is a flow chart describing the method of coupling a securing apparatus to a fishing lure.

### DETAILED DESCRIPTION

The following detailed description illustrates embodiments of the present disclosure. These embodiments are described in sufficient detail to enable a person of ordinary skill in the art to practice these embodiments without undue experimentation. It should be understood, however, that the embodiments and examples described herein are given by way of illustration only, and not by way of limitation. Various substitutions, modifications, additions, and rearrangements may be made that remain potential applications of the disclosed techniques. Therefore, the description that follows is not to be taken as limiting on the scope of the appended claims. In particular, an element associated with a particular embodiment should not be limited to association with that particular embodiment but should be assumed to be capable of association with any embodiment discussed herein.

Recreational fishing, whether through competition or leisure, is enjoyed by many of those participating or spectating. The art of fishing may require aquatic vehicles that are as advanced as personal boats for deep sea fishing to simplistic tools such as coolers to store perishable items while fishing off a dock. Other tools may include fishing lures, fishing poles, nets, water-resistant shoes, etc. Managing this equipment can be cumbersome and overwhelming. In addition, handling some of the tools can pose a risk. For example, barb hooks coupled to fishing lures are hazardous when handled incorrectly or hastily. For example, a fisherman can be poked or stabbed when handling a fishing lure. The same issue occurs when the fisherman tries to decouple entangled fishing lures from one another when stored in a tacklebox.

The securing apparatus described herein conceals the fishing lure's barbed hooks and restricts the hooks from dangling freely and snagging on other fishing lures in the tackle box or other storage compartments within your fishing gear. The securing apparatus is made of an elastic silicone, such as thermosetting polymer that is heat resistance of up to 500 degrees Fahrenheit (260° Celsius) and is not susceptible to ultra-violet (UV) rays. The securing apparatus may be made of other similar material with the same characteristics as the thermosetting polymer. The securing apparatus is also flexible and stretchable to accommodate a variety of fishing lures.

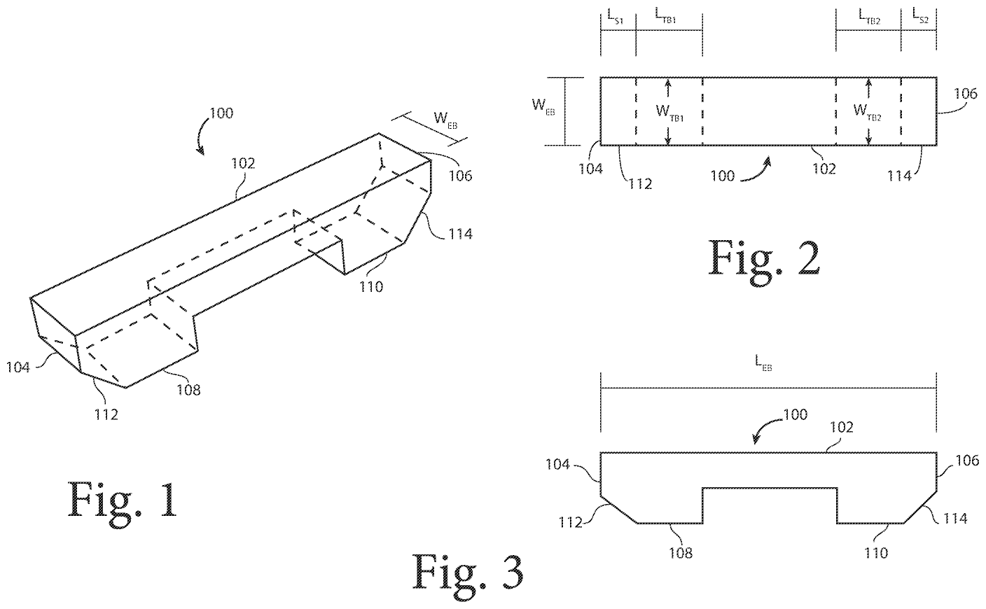

FIG. 1 is perspective view of a securing apparatus. FIG. 2 is an ariel view of a securing apparatus. FIG. 3 is a profile view of a securing apparatus. In one or more embodiments, the securing apparatus 100 is manufactured from a thermosetting polymer, or other similar material, that is heat resistant of up to 500 degrees Fahrenheit (260° Celsius) and is not susceptible to ultra-violet (UV rays). The securing apparatus is flexible and stretchable to accommodate a variety of fishing lures and their respective barbed hook positions.

As illustrated in FIGS. 1-3 the securing apparatus 100 may include an elongated body 102. The elongated body 102 may have a body width W_{EB} of between 0.25 inches (0.635 centimeters) and one inch (2.54 centimeters). As indicated in FIG. 3, the elongated body 102 may have a body length L_{EB} of between 1.25 inches (3.175 centimeters) and 2.25 inches (5.715 centimeters).

In one or more embodiments, as illustrated in FIGS. 1-3, the securing apparatus 100 includes a first body end 104 and a second body end 106 opposite the first body end 104. As illustrated in FIGS. 1-2, the securing apparatus 100 may include a first truncated body 108 integrally coupled to the first body end 104. The securing apparatus 100 may include a second truncated body 110 integrally coupled to the second body end 110. The first truncated body 108 may have a body width W_{TB1} of between 0.25 (0.635 centimeters) and one inch (2.54 centimeters) and a body length L_{TB1} of between 0.375 inches (0.9525 centimeters) and 1.5 inches (3.81 centimeters). In one or more embodiments, the second truncated body 110 may have a body width W_{TB2} of between 0.25 (0.635 centimeters) and one inch (2.54 centimeters) and a body length L_{TB2} of between 0.375 inches (0.9525 centimeters) and 1.5 inches (3.81 centimeters).

The first truncated body 108 may include a first ridge 112. The first ridge 112 slopes down towards the first body end 104. The second truncated body may include a second ridge 114. The second ridge 114 slopes down towards the second body end 106. In one or more embodiments, the first ridge 112 has a length L_{S1} of between 0.125 inches (0.3175 centimeters) and 0.5 inches (1.27 centimeters). In one or more embodiments, the second ridge 114 has a length L_{S2} of between 0.125 inches (0.3175 centimeters) and 0.5 inches (1.27 centimeters).

FIG. 4 is a profile view of a securing apparatus coupled to a fishing lure. As illustrated in FIG. 4, the securing apparatus 100 is coupled to a fishing lure 402 by way of two barbed hooks attached to the fishing lure 402. The fishing lure 402 may have a first hook 404 and a second hook 406. In one or more embodiments, the fishing lure 402 may have more or less hooks than illustrated in FIG. 4. In one embodiment, to secure the fishing lure 402 to the securing apparatus 100, the first hook 404 is isolated from the second hook 406 and pierced into the first truncated body 108. In addition, the second hook 406 is isolated and pierced into the second truncated body 110. Note, either hooks 404 and 406 may be pierced into either the first truncated body 108 or the second truncated body 110.

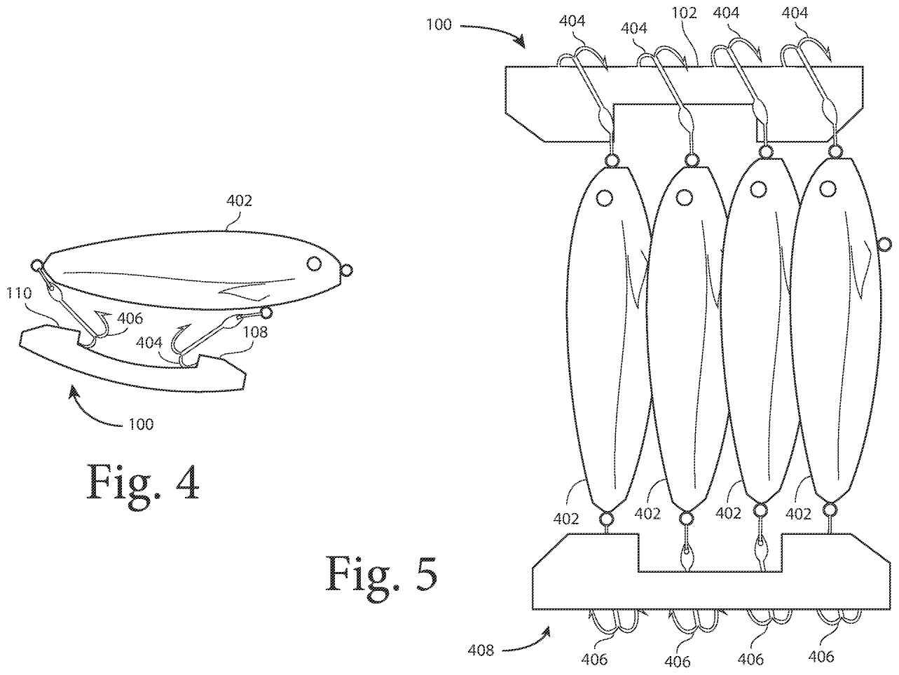

FIG. 5 is a profile view of two securing apparatus coupled to an array of fishing lures. As illustrated in FIG. 5, the securing apparatus 100 may secure a collection of fishing lures 402. To secure a collection of fishing lures 402, the hook (either first hook 404 or second hook 406) is pierced along the elongated body 102 of the securing apparatus 100. This step is repeated for additional fishing lures 402 as space on the elongated body 102 is allowed. If applicable, and for additional security, a second securing apparatus 408 may be coupled to the remaining free dangling hooks as illustrated in FIG. 5.

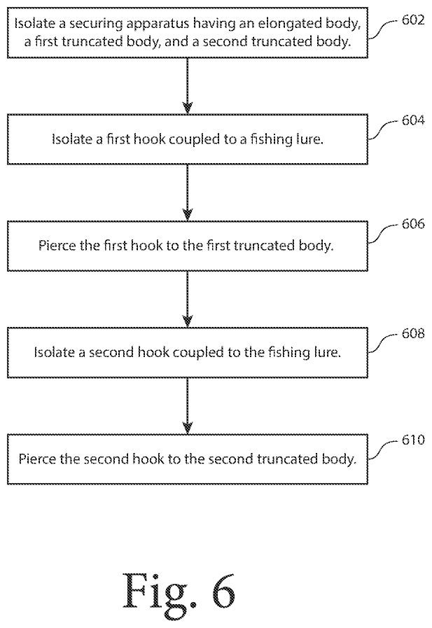

FIG. 6 is a flow chart describing the method of coupling a securing apparatus to a fishing lure. The method includes isolating a securing apparatus (such as securing apparatus 100) having an elongated body (such as elongated body 102), a first truncated body (such as truncated body 108), and a second truncated body (such as second truncated body 110) (block 602). Isolating a first hook (such as first hook 404) coupled to a fishing lure (such as fishing lure 402) (block 604). Piercing the first hook (such as first hook 404) to the first truncated body (such as first truncated body 108) (block 606). Isolate a second hook (such as second hook 406) coupled to the fishing lure (such as fishing lure 402) (block 608). Pierce the second hook (such as second hook 406) to the second truncated body (such as second truncated body 110) (block 610).

In one aspect, an apparatus for securing dangling hooks on a fishing lure includes an elongated body having a first body end and a second body end opposite the first body end. A first truncated body is integrally coupled to the first body end. The first truncate body has a first ridge. A second truncate body is integrally coupled to the second body end. The second truncated body has a second ridge.

Implementation may include one or more of the following. The elongated body, the first truncated body, and the second truncated body may be comprised of thermosetting polymer. The elongated body may have a body width W_{EB} of between 0.25 inches and one inch and a body length L_{EB} of between 1.25 inches and 2.25 inches. The first truncated body may have a body width W_{TB1} of between 0.25 inches and one inch and a body length L_{TB1} of between 0.375 inches and 1.5 inches. The second truncated body may have a body width W_{TB2} of between 0.25 inches and one inch and a body length L_{TB2} of between 0.375 inches and 1.5 inches. The first ridge may have a length L_{S1} of between 0.125 inches and 0.5 inches. The second ridge may have a length L_{S2} of between 0.125 inches and 0.5 inches.

In one aspect, the system for securing dangling hooks on a fishing lure includes a fishing lure having hooks. The system includes a securing apparatus coupled to the hooks. The securing apparatus includes an elongated body having a first body end and a second body end opposite the first body end. A first truncated body is integrally coupled to the first body end. The first truncate body has a first ridge. A second truncate body is integrally coupled to the second body end. The second truncated body has a second ridge.

Implementation may include one or more of the following. The elongated body, the first truncated body, and the second truncated body may be comprised of thermosetting polymer. The elongated body may have a body width W_{EB} of between 0.25 inches and one inch and a body length L_{EB} of between 1.25 inches and 2.25 inches. The first truncated body may have a body width W_{TB1} of between 0.25 inches and one inch and a body length L_{TB1} of between 0.375 inches and 1.5 inches. The second truncated body may have a body width W_{TB2} of between 0.25 inches and one inch and a body length L_{TB2} of between 0.375 inches and 1.5 inches. The first ridge may have a length L_{S1} of between 0.125 inches and 0.5 inches. The second ridge may have a length L_{S2} of between 0.125 inches and 0.5 inches.

In one aspect the method for securing dangling hooks on a fishing lure includes isolating a securing apparatus. The securing apparatus has an elongated body having a first body end and a second body end opposite the first body end. A first truncated body is integrally coupled to the first body end. The first truncated body has a first ridge. A second truncated body is integrally coupled to the second body end. The second truncated body having a second ridge. The first hook coupled to the fishing lure is isolated. The first hook is pierced into the first truncated body.

Implementations may include one or more of the following. A second hook coupled to the fishing lure may be isolated and pierced into the second truncated body. A first hook coupled to a second fishing lure may be isolated and pierced into the elongated body. A first hook coupled to a third fishing lure may be isolated and pierced into the elongated body. A first hook coupled to a fourth fishing lure may be isolated and pierced into the elongated body. The second hooks coupled to the first, second, third, and fourth fishing lures may be pierced into a second securing apparatus elongated body.

The operations of the flow diagrams are described with references to the systems/apparatus shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

The word “coupled” herein means a direct connection or an indirect connection.

The text above describes one or more specific embodiments of a broader invention. The invention also is carried out in a variety of alternate embodiments and thus is not limited to those described here. The foregoing description of an embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. An apparatus for securing dangling hooks on a fishing lure comprising:
an elongated body having:
a first body end; and
a second body end opposite the first body end;
a first truncated body integrally coupled to the first body end, the first truncated body having a first ridge; and
a second truncated body integrally coupled to the second body end, the second truncated body having a second ridge.

2. The apparatus of claim 1 wherein the elongated body, the first truncated body, and the second truncated body are comprised of thermosetting polymer.

3. The apparatus of claim 1 wherein the elongated body has a body width W_{EB} of between 0.25 inches and one inch and a body length L_{EB} of between 1.25 inches and 2.25 inches.

4. The apparatus of claim 1 wherein the first truncated body has a body width W_{TB1} of between 0.25 inches and one inch and a body length L_{TB1} of between 0.375 inches and 1.5 inches.

5. The apparatus of claim 1 wherein the second truncated body has a body width W_{TB2} of between 0.25 inches and one inch and a body length L_{TB2} of between 0.375 inches and 1.5 inches.

6. The apparatus of claim 1 wherein the first ridge has a length L_{S1} of between 0.125 inches and 0.5 inches.

7. The apparatus of claim 1 wherein the second ridge has a length L_{S2} of between 0.125 inches and 0.5 inches.

8. A system for securing dangling hooks on a fishing lure comprising:
a fishing lure having hooks;
a securing apparatus coupled to the hooks, the securing apparatus having:
an elongated body having:
a first body end; and
a second body end opposite the first body end;
a first truncated body integrally coupled to the first body end, the first truncated body having a first ridge; and
a second truncated body integrally coupled to the second body end, the second truncated having a second ridge.

9. The system of claim 8 wherein the elongated body, the first truncated body, and the second truncated body are comprised of thermosetting polymer.

10. The system of claim 8 wherein the elongated body has a body width W_{EB} of between 0.25 inches and one inch and a body length L_{EB} of between 1.25 inches and 2.25 inches.

11. The system of claim 8 wherein the first truncated body has a body width W_{TB1} of between 0.25 inches and one inch and a body length L_{TB1} of between 0.375 inches and 1.5 inches.

12. The system of claim 8 wherein the second truncated body has a body width W_{TB2} of between 0.25 inches and one inch and a body length L_{TB2} of between 0.375 inches and 1.5 inches.

13. The system of claim 8 wherein the first ridge has a length L_{S1} of between 0.125 inches and 0.5 inches.

14. The system of claim 8 wherein the second ridge has a length L_{S2} of between 0.125 inches and 0.5 inches.

15. A method for securing dangling hooks on a fishing lure comprising:
isolating a securing apparatus, the securing apparatus having:
an elongated body having:
a first body end; and
a second body end opposite the first body end;
a first truncated body integrally coupled to the first body end, the first truncated body having a first ridge; and
a second truncated body integrally coupled to the second body end, the second truncated body having a second ridge;
isolating a first hook coupled to the fishing lure; and
piercing the first hook to the first truncated body.

16. The method of claim 15 further comprising:
isolating a second hook coupled to the fishing lure; and
piercing the second hook to the second truncated body.

17. The method of claim 15 further comprising:
isolating a first hook coupled to a second fishing lure; and
piercing the first hook to the elongated body.

18. The method of claim 17 further comprising:
isolating a first hook coupled to a third fishing lure; and
piercing the first hook to the elongated body.

19. The method of claim 18 further comprising:
isolating a first hook coupled to a fourth fishing lure; and
piercing the first hook to the elongated body.

20. The method of claim 19 further comprising piercing second hooks coupled to the first, second, third, and fourth fishing lures to a second securing apparatus elongated body.
